(19) United States
(12) Patent Application Publication
(10) Pub. No.: US 2025/0254182 A1
(43) Pub. Date: Aug. 7, 2025

(54) Dynamic signature selection systems and methods

(71) Applicant: Sophos Limited, Abingdon (GB)

(72) Inventors: Mukesh Kumar, Bangalore (IN); Santosh Subramanya, Bangalore (IN); Sooraj K S, Bengaluru (IN); Sean McDonald, New South Wales (AU)

(21) Appl. No.: 18/434,624

(22) Filed: Feb. 6, 2024

(51) Int. Cl. H04L 9/40

(52) U.S. Cl. CPC H04L 63/1416; H04L 63/1425; H04L 63/1433

(57) ABSTRACT

Systems and methods for detecting threats using threat signatures loaded in a computing device. The method includes receiving a first plurality of threat signatures at a computing device on a first network location; storing the first plurality of threat signatures in read only memory (ROM) of the computing device; and monitoring, using the computing device, network activity by executing at least one of: a telemetry module, a network profiler module, and a machine learning module. The method further includes creating a customized signature set by selecting a second plurality of threat signatures from the first plurality of threat signatures based on output from at least one or more of the telemetry module, the network profiler module, or machine learning module, loading the customized signature set into random access memory (RAM) of the computing device, and scanning network activity using the customized signature set.

### TECHNICAL FIELD

The present application relates generally to threat management systems and methods and, more particularly but not exclusively, systems and methods for detecting threats using signature-based scanning of network activity.

### BACKGROUND

Network threats may be detected by inspection at various levels. Many threat detection technologies operate by inspecting data in various states such as in transit, in storage, in memory, during processing, or the like, and then checking whether the data matches specific criteria provided as a signature. One or more signatures can detect one or more threats such as ransomware, malware, malformed packets, software vulnerabilities, and other such threats or combinations thereof.

The number of threats continues to increase each year. Accordingly, the number of signatures needed to detect these threats increases as well. A computing device such as a firewall may be configured to store signatures, and then use the signatures to identify threats and/or prevent an identified threat. However, a computing device may have limited computing resources (e.g., memory, processors, network bandwidth, and so forth) for storing and using these signatures.

Intrusion detection systems or intrusion prevention systems protect networks against malicious actors. The efficacy of these systems may improve by adding new signatures which, in theory, helps block a greater number of threats or attacks.

However, adding new signatures or otherwise increasing the number of signatures puts more pressure on the throughput of the system. For example, the more signatures there are, the more pattern-matching processes the systems will perform. Additionally, these systems may use an unnecessary amount of signatures, such that some will be matched and triggered on benign traffic. In these cases, the match would be a false positive.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

The embodiments herein provide systems and methods to process electronic communications. The embodiments herein generate dynamic, customer-specific signature sets to enhance coverage and improve performance of network security devices. One or more modules may passively gather data regarding activity occurring on a network. For example, these module(s) may passively gather data regarding vulnerabilities being targeted on a network, vendors being used on a network, products being used on a network, application(s) being used on a network, protocol(s) being used on a network, etc. or some combination thereof.

Once this data is obtained, the embodiments herein may generate a customer-specific set of signatures for monitoring activity on the customer's network. This customer-specific signature set may be loaded into random access memory (RAM) of a network security device such as a firewall. The network security device may then scan network activity using the customer-specific signature set.

### BRIEF DESCRIPTION OF DRAWINGS

Non-limiting and non-exhaustive embodiments of the invention are described with reference to the following figures, wherein like reference numerals refer to like parts throughout the various views unless otherwise specified:

FIG. 1 illustrates a block diagram of a threat management system in accordance with one embodiment;

FIG. 2 illustrates an instantiation of the firewall of FIG. 1 in accordance with one embodiment;

FIG. 3 illustrates the telemetry module of FIG. 2 in accordance with one embodiment;

FIG. 4 illustrates the network profiler module of FIG. 2 in accordance with one embodiment;

FIG. 5 presents a protocol identification instance in accordance with one embodiment;

FIG. 6 presents a protocol identification instance in accordance with another embodiment;

FIG. 7 presents an operating system identification instance in accordance with one embodiment;

FIG. 8 presents a server identification instance in accordance with one embodiment;

FIG. 9 presents a browser identification instance in accordance with one embodiment;

FIG. 10 presents a protocol identification instance using hex bytes in accordance with one embodiment;

FIG. 11 presents a protocol identification instance using hex bytes in accordance with another embodiment;

FIG. 12 presents a protocol identification instance using hex bytes in accordance with another embodiment;

FIG. 13 illustrates an instantiation of the firewall of FIG. 1 in accordance with another embodiment; and

FIG. 14 depicts a flowchart of a method for detecting threats using threat signatures in accordance with one embodiment.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Entities such as enterprise networks commonly implement Intrusion Detection Systems, Intrusion Prevention Systems, or both (for simplicity, “IDS/IPS”). IDS/IPS provide protection mechanisms for the entity against malicious actors.

IDS/IPS typically work by comparing network traffic or activity against a predefined set of signatures to match patterns of network activity with activity known to be malicious or likely malicious. IDS/IPS can be classified as network-based or host-based, the classification of which depends on where the IDS/IPS is installed or otherwise located. Network-based systems may be installed at locations from which they can monitor all traffic before it enters a network or a subnet. In this location, if the system detects malicious activity or traffic, it may block or otherwise prevent the traffic from entering or leaving the network.

Host-based systems may be installed at the endpoint level, and can be configured as a physical machine or a virtual machine. These systems may inspect traffic before it enters the endpoint device on which it is installed, thereby blocking malicious traffic from entering or leaving the endpoint.

As discussed previously, there are competing interests in configuring an IDS/IPS with signatures. On one hand, the IDS/IPS should monitor traffic using a sufficient number or set of signatures to detect malicious activity. On the other hand, using too many signatures may degrade performance of the IDS/IPS or potentially lead to false positives.

Different networks or subnets may have different types of network activity occurring thereon. As a result, these different networks and subnets may have different requirements or expectations of their firewalls or other types of network security devices.

For example, customers who are using only Windows® operating systems should be using signatures applicable for Windows® services or products. That is, there would be no reason for the customer's firewall in this case to apply, e.g., signatures associated with Linux or Mac® operating systems.

As another example, customers using just client-side applications on their network shouldn't be using server-side signatures. Similarly, if customers are not using products such as Microsoft (MS) Office available from Microsoft Corporation, headquartered in Redmond, Washington, they shouldn't be using signatures for Office products (Word, Excel, etc.). As another example, customers who do not use an FTP server shouldn't be using signatures that provide protection for FTP servers.

The embodiments herein passively gather data about a customer's network to determine the most appropriate signatures for that network. The systems and methods described herein may generate dynamic, customer-specific signature sets to not only enhance coverage for a customer but improve performance of the customer's network security device(s).

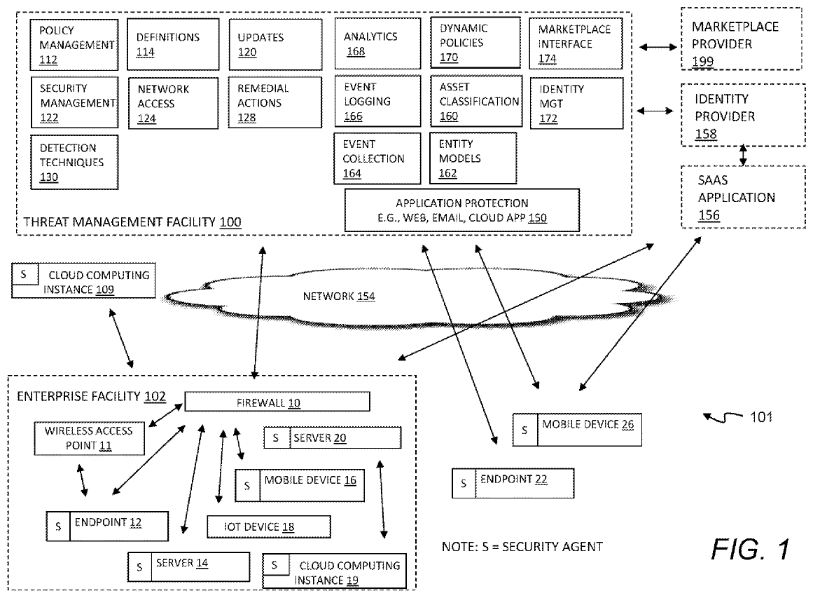

FIG. 1 illustrates a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, the enterprise facility 102 may be or may include any networked computer-based infrastructure. For example, the enterprise facility 102 may be corporate, commercial, organizational, educational, governmental, or the like. As home networks become more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is by way of example, and it will be understood that there may be any number of compute instances, less or more of each type of compute instances, and other types of compute instances. As shown, the enterprise facility includes a firewall 10, a wireless access point 11, an endpoint 12, a server 14, a mobile device 16, an appliance or Internet-of-Things (IoT) device 18, a cloud computing instance 19, and a server 20. Again, the compute instances 10-20 depicted are by way of example, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include or otherwise be in communication certain facilities, such as a policy management facility 112, security management facility 122, update facility 120, definitions facility 114, network access facility 124, remedial action facility 128, detection techniques facility 130, one or more hosted services 132, a cloud controller 134, application protection 150, asset classification facility 160, entity model facility 162, event collection facility 164, event logging facility 166, analytics facility 168, dynamic policies facility 170, identity management facility 172, and marketplace interface facility 174, a firmware repository 176, a build system 178, as well as other facilities. For example, there may be a testing facility, a threat research facility, and other facilities (not shown). It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility 102. Some or all of one or more of the facilities 100, 112-174 may be provided on the same physical hardware or logical resource as a gateway, such as a firewall 10, or wireless access point 11. Some or all of one or more of the facilities 100, 112-174 may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider 199 may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility 100. For example, the marketplace provider 199 may subscribe to and receive certain events, and in response, based on the received events and other events available to the marketplace provider 199, send inferences to the marketplace interface facility 174, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider 158 may be any system or entity that creates, maintains, and manages identity information for principals while providing authentication services to relying party applications, e.g., within a federation or distributed network. The identity provider 158 may, for example, offer user authentication as a service, where other applications, such as web applications, outsource the user authentication step(s) to a trusted identity provider.

In embodiments, the identity provider 158 may provide user identity information, such as multi-factor authentication, to a software-as-a-service (SaaS) application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 or other type of computing device outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop or other type of public location. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22 or 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Examples of commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an network 154 such as the Internet or any other public network, private network or combination thereof.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to the facility 100. Alternatively, the threat management facility 100 may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in a security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, or unwanted applications; help control web browsing; and the like, which may provide comprehensive web access control to enable safe and productive web browsing. Web security and control may provide Internet use policies, reporting on suspect compute instances, security and content filtering, active monitoring of network traffic, Uniform Resource Identifier (URI) filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. These policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of Universal Serial Bus (USB) disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access.

The policy management facility 112 may also require update management (e.g., as provided by the update facility 120). Update management for the security management facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security management facility 122 and policy management facility 112 may push information to the enterprise facility 102 network and/or the compute instances 10-26, the enterprise facility 102 network and/or compute instances 10-26 may pull information from the security management facility 122 and policy management facility 112, or there may be a combination of pushing and pulling of information. For example, the enterprise facility 102 network and/or compute instances 10-26 may pull update information from the security management facility 122 and policy management facility 112 via the update facility 120, an update request may be based on a time period, by a certain time, by a date, on demand, or the like. In another example, the security management facility 122 and policy management facility 112 may push the information to the enterprise facility's 102 network and/or compute instances 10-26 by providing notification that there are updates available for download and/or transmitting the information. In an embodiment, the policy management facility 112 and the security management facility 122 may work in concert with the update facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, macOS, OS X, Linux, Android, IOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility 100 may include the entity model facility 162. The entity models may be used, for example, to determine the events that are generated by assets. For example, some operating systems may provide useful information for detecting or identifying events. For examples, operating systems may provide process and usage information that accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. One example of an event is the communication of a specific packet over the network. Another example of an event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 128 may take any steps or deploy any measures suitable for addressing a detection of a threat, potential threat, policy violation or other event, code or activity that might compromise security of a computing instance 10-26 or the enterprise facility 102.

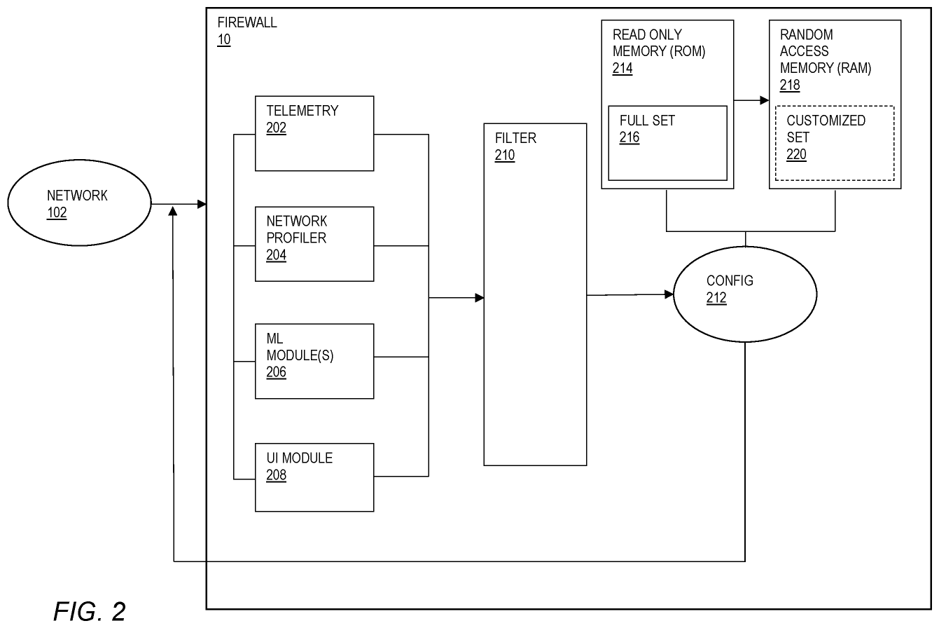

FIG. 2 illustrates an instantiation of the firewall 10 of FIG. 1 in accordance with one embodiment. As seen in FIG. 1, the firewall 10 may be located on or otherwise in communication with an enterprise facility 102 or network. For example, the firewall 10 may be configured to monitor traffic being sent to the enterprise facility 102, traffic being sent from the enterprise facility 102, or both.

The firewall 10 may include or otherwise execute one or more of a telemetry module 202, a network profiler module 204, a machine learning module(s) 206, and a user interface (UI) module 208. Each of these modules may be configured to passively gather data or otherwise receive data regarding network activity.

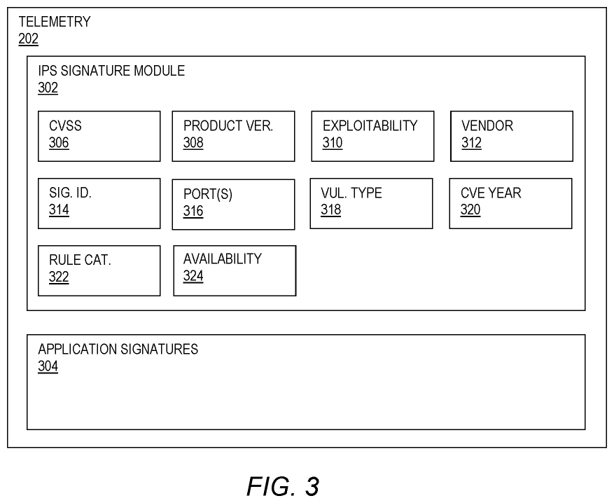

FIG. 3 illustrates an instantiation of the telemetry module 202 of FIG. 2 in accordance with one embodiment. The telemetry module 202 may include or otherwise execute an IPS signature module 302 and an application signatures module 304. One or more of these modules or submodules thereof may be implemented as background services that reference rules or policies upon receiving data associated with a signature, discussed below. For example, in some embodiments, one or more of these modules or submodules may be implemented as a daemon program.

The telemetry module 202 may be configured to gather telemetry data associated with signatures. In the context of the present application, “telemetry data” may refer to the characteristics of a connection. These may include, but are not limited to, any one or more of source IP address of a connection, destination IP address of a connection, destination port(s), source port(s), time of connection, duration of connection, counts of signature triggers across all customers, counts of unique customer boxes on which a signature has triggered, counts of signatures triggered on each customer box, or the like.

Accordingly, whenever a signature triggers (i.e., is matched with a pattern associated with network traffic), the IPS signature module 302 may identify certain information associated with the signature. In some embodiments, the IPS signature module 302 may execute various submodules to identify or analyze certain data associated with the triggering signature. These may include one or more of a Common Vulnerability Scoring System score (“CVSS”) submodule 306, product version submodule 308, exploitability submodule 310, vendor submodule 312, signature identification (ID) submodule 314, port(s) submodule 316, vulnerability type submodule 318, common vulnerability (CVE) year submodule 320, rule category submodule 322, and availability submodule 324. Some of the above-discussed metadata may have been added to the signature during development and/or retrieved from cloud-based data services. One or more of the various submodules 306-24 may be background services that, upon receipt of data associated with a triggering signature, may execute string-matching procedures to detect strings that are common in signature-associated data.

The CVSS submodule 306 module may determine a CVSS score assigned to a signature based on the criticality of the threat associated with the signature. The determined CVSS score may be a number selected from a predetermined range, such as the range of one through ten. Furthermore, scores may be grouped into one or more predefined and/or predetermined groups. In this manner, the value of the CVSS score may indicate the criticality of a particular signature.

The product version submodule 308 may identify the version of a product associated with a connection. This may indicate whether a product is executing outdated firmware, for example.

The exploitability submodule 310 may analyze whether a threat associated with a signature is a Common Vulnerabilities and Exposures (CVE) that is exploited in the wild. If a CVE is exploited, it may indicate a signature match is more critical than other matching signatures.

The vendor submodule 312 may determine the vendor of software on which the signature, and classify the signature based on the associated vendor. In one embodiment, the vendor submodule 312 may include a data structure, e.g., a two-dimensional table or the like, that correlates a particular vendor with a vulnerability type group. For example, if the vendor submodule 312 determines that a signature is associated with a vendor such as MICROSOFT®, the vendor submodule 312 may group the signature into a vulnerability type group that indicates a vendor is widely popular and/or whether exploits are more likely to be directed to its products.

The Signature Identification (ID) submodule 314 may identify any type of signature ID associated with the signature. For example, each signature may be assigned an identification number or other type of indicia.

The port(s) submodule 316 may identify a port associated with a connection. Certain port numbers or ranges thereof may be associated with different protocols. Accordingly, if a port of a connection is identified and receiving traffic, the port(s) submodule 316 may identify the associated protocol.

The vulnerability type submodule 318 may analyze a signature to determine the type of vulnerability associated therewith. The vulnerability type submodule 318 may reference one or more databases (not shown in FIG. 3) storing records associated with a signature, which may list the type of vulnerability (e.g., a Bypass vulnerability, a Denial-of-Service vulnerability, etc.) associated with a signature. The vulnerability type submodule 318 may also consider characteristics or patterns associated with a signature to determine the type of vulnerability. By analyzing a vulnerability type associated with a particular signature, the vulnerability type submodule 318 may also classify a signature into one of several vulnerability type groups.

The CVE year submodule 320 may determine the year in which a CVE associated with a signature was released. The CVE Year submodule 320 may assign higher scores to more recent CVEs, as they are likely more critical. For example, there may be several remediations available for older CVEs, but less remediations available for newer CVEs.

The rule category submodule 322 may determine a category assigned to a signature based on what is known about the vulnerability (e.g., via metadata associated with the signature) or general traffic the signature aims to detect at the time of signature creation. The category to which a signature is assigned may be based on vendor, application, protocol, vulnerability type, or general aim of the signature, or some combination thereof.

The availability submodule 324 may be configured to determine whether there is a published exploit available for a threat associated with a signature. The availability module 324 may be configured as a binary classifier and further configured to assign a score of one to a signature if an associated threat has an available exploit, and a score of zero to a signature if there is no exploit available.

The application signatures module 304 may identify different applications that are being used. For example, the application signatures module 304 may include signatures associated with applications such that, if there is a match on a network, the application signatures module 304 can conclude that the corresponding application is being executed on the network. These application signatures may identify patterns and behavior in network traffic. For example, to detect access to Youtube.com, the application signatures module 304 may check for the Server Name Indication (SNI) used in establishing the connection, such as “alert tcp any any->any 443 (checkappid:2000,100; sid 10000; msg: “Youtube Detected”; flow:from_client, established; ssl_state:client_hello; content: “.youtube.com”; fast_pattern:only; appid:2000;)].”

The output of the telemetry module 202 may include various data about telemetry of triggered signatures. Specifically, based on a signature triggering on a customer's network, this telemetry data can provide data such as what vulnerabilities are being exploited on the customer's network, which vendors have products in use on the customer's network, which products are being used on the network, data about products being used on the customer's network, or the like.

From this data, the embodiments herein can add signatures that have triggered in telemetry for one or more specific customers. Based on the vendor or product data, the embodiments herein may assign signatures for those vendors or products.

Referring back to FIG. 2, the firewall 10 may also include or otherwise execute a network profiler module 204. The network profiler module 204 may use a variety of techniques to passively identify vendors, products, applications, protocols, or some combination thereof. In some embodiments, the network profiler module 204 or components thereof may be implemented as background service that reference rules or policies for extracting data from network traffic.

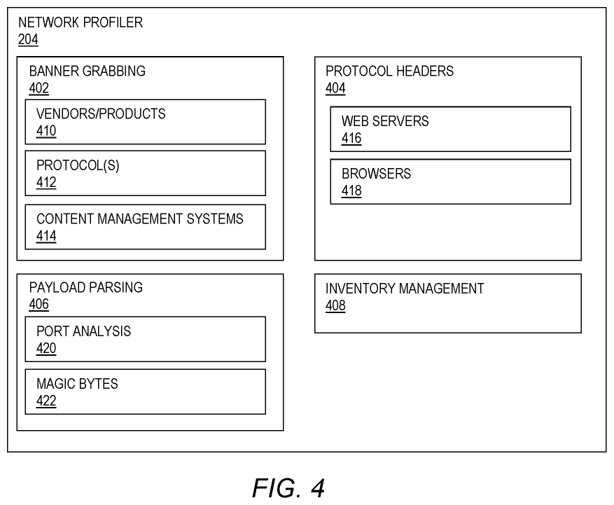

FIG. 4 illustrates an instantiation of the network profiler module 204 in accordance with one embodiment. The network profiler module 204 may include or otherwise execute a banner grabbing module 402, a protocol headers module 404, a payload parsing module 406, and an inventory management module 408.

The banner grabbing module 402 may be configured to extract information by inspecting data that is being sent in request-response transactions during a client-server interaction. This not only helps gather data about products, but also data about protocols in use. As seen in FIG. 4, the banner grabbing module 402 may include or otherwise execute a vendors/products submodule 410, a protocol(s) submodule 412, and a content management systems (CMS) submodule 414.

The vendors/products submodule 410 may be configured to obtain data about vendors of software used for several application layer protocols. These application layer protocols may include, but are not limited to, Hypertext Transfer protocol (HTTP), file transfer protocol (FTP), simple mail transfer protocol (SMTP), post office protocol (POP3), internet message access protocol (IMAP), simple network management protocol (SNMP), trivial file transfer protocol (TFTP), or the like.

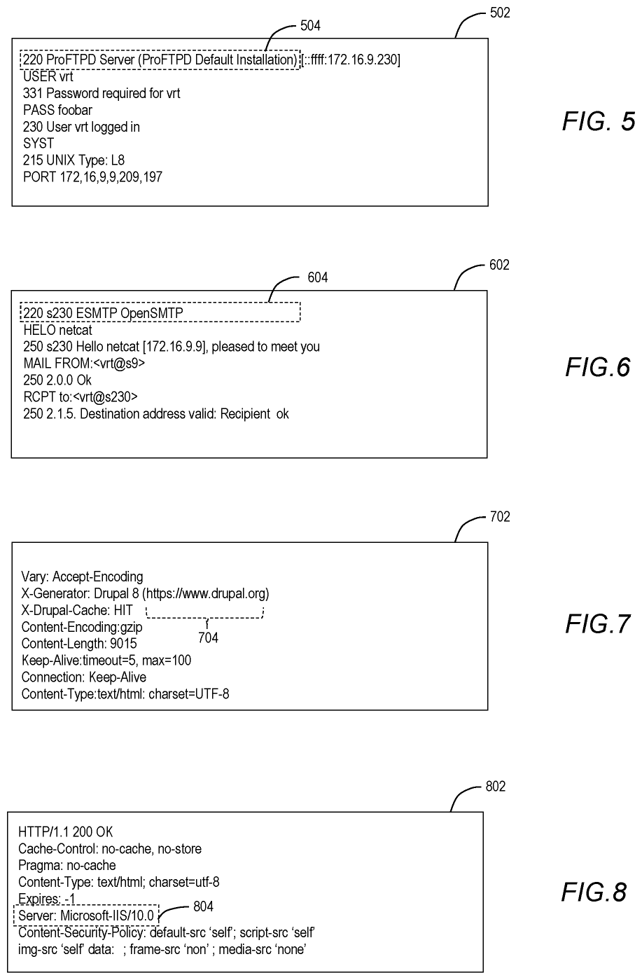

For example, FIG. 5 presents a protocol identification instance 502 in accordance with one embodiment. In this instance, the identification 504 shows that a File Transfer Protocol (FTP) server is used in the network.

As another example, FIG. 6 presents a protocol identification instance 602 in accordance with another embodiment. In this instance, the identification 604 shows that an SMTP server is used in the network.

Referring back to FIG. 4, the protocol(s) submodule 412 may extract from banners data regarding protocols used in a network. Extracting data from banners may enable the embodiments herein to identify servers, browsers, content management systems, or the like. From this data, and specifically request/response packets, the protocol(s) submodule 412 may identify protocols such as HTTP, SMTP, SNMP, FTP, SSH, POP3, IMAP, TFTP.

For example, the protocol(s) submodule 412 may analyze a request “SSH-2.0-OpenSSH-7.6p1 Ubuntu-4ubuntu0.5.” In this example, the protocol(s) submodule 412 would identify the Protocol as Secure Shell (SSH), the product as “OpenSSH,” and the Operating System as “Ubuntu.”

The Content Management System (CMS) submodule 414 may identify content management systems. There are many content management systems used worldwide. These include, but are not limited to, WordPress, Drupal, and Joomla. The CMS submodule 414 may identify these by inspecting a header such as an HTTP response header.

FIG. 7 presents a content management system identification instance 702 in accordance with one embodiment. In this example, the CMS submodule 414 may identify 704 from a response header that www.drupal.org is used as a content management system.

Headers may differ for different types of content management systems. For example, and as seen in FIG. 7 in the case of Drupal, the content management system can be found under the “X-Generator” header. As another example, in the case of WordPress, it can be found under the “X-Redirect-By” header. Accordingly, the CMS submodule 414 may execute string-matching procedures on designated fields to identify an applicable content management system.

The protocol headers module 404 may identify application or product data from headers. Many applications and products leave some type of fingerprint in network traffic, and the protocol headers module 404 may extract this type of data from specific response headers.

The web servers submodule 416 may identify web server data by inspecting HTTP response headers. For example, FIG. 8 presents a server identification 802 in accordance with one embodiment. The web servers submodule 416 may identify 804 a web server of a network connection by inspecting an HTTP response header. The server name can be found under the header “Server.” As indicated in FIG. 8, the server is identified as Microsoft-IIS/10.0.

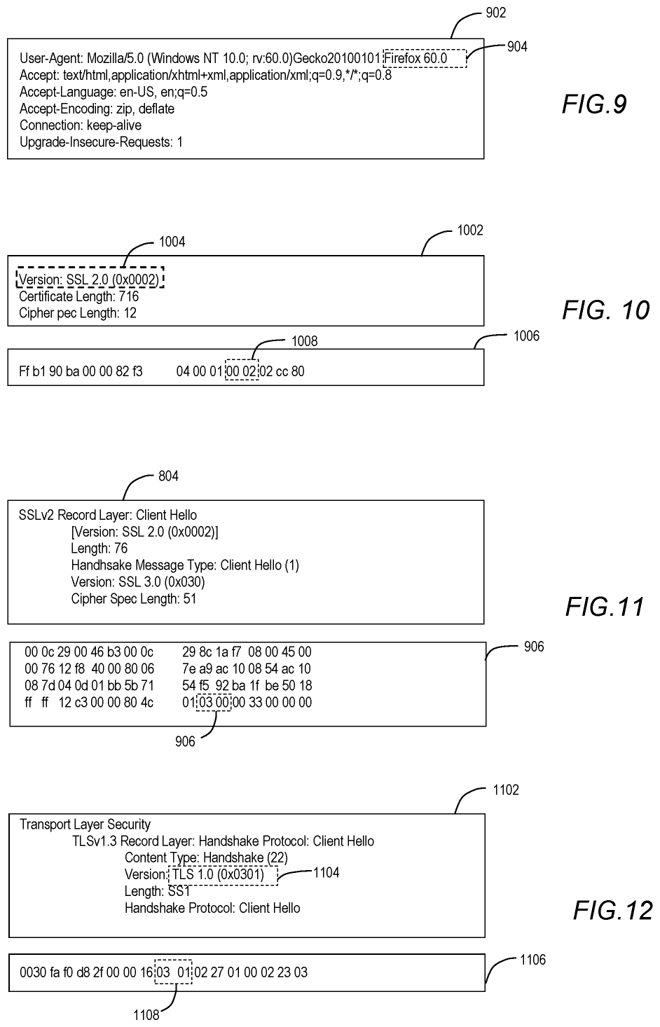

The browsers submodule 418 may identify browsers used in a network connection by inspecting a header such as an HTTP response header. The browser can be found under the header “User-Agent.” FIG. 9 presents a browser identification 902 in accordance with one embodiment. FIG. 9 presents an HTTP Request/Response header, from which the browsers submodule 418 may be configured to inspect the User-Agent header. As seen in FIG. 9, the browsers submodule 418 has indicated 904 Firefox/60.0 as the browser.

In view of the above, the network profiler module 204 can identify the product from captured banner data. Similarly, the network profiler 204 can identify from protocol headers data the protocol(s) used. For example, from the banner grabbing procedures, the embodiments herein can determine that an APACHE® product being used. From the protocol headers, the embodiments herein can determine that communications are occurring over HTTP. For signature selection, as discussed below, the embodiments herein can apply signatures that satisfy both conditions (i.e., Apache-related signatures for communications over HTTP).

The payload parsing module 406 may include or otherwise execute a port analysis submodule 420, a magic bytes submodule 422, or both. The port analysis submodule 420 may analyze ports in network connections to identify the protocol(s). For example, ports in the range of 0-1023 have different protocols associated with them. Accordingly, the port analysis submodule 420 can identify whether traffic is going to certain ports to identify an associated protocol. For example, SMB protocol traffic will go over TCP port nos. 445 and 139. Also, to verify if this protocol is being used or not, the port analysis submodule 420 or other component may check the request/response packet as well.

In the transmission control protocol (TCP), for example, a decision on whether a protocol is used may be made once a 3-way handshake is completed. In the user datagram protocol (UDP), a decision on whether a protocol is used may be made once both a request and response on the analyzed port is observed.

The magic bytes submodule 422 may analyze hex bytes to identify a file type or protocol being used in a communication. Many files can be identified by a unique set of hex bytes, usually present in the beginning of the file. Sets of signatures may vary from a few hex bytes to a string of characters. The magic bytes submodule 422 may observe these patterns at a fixed offset and depth in a transaction. For example, to identify a Zip file, the magic bytes associated with a Zip file are |50 4B 03 04| and are present in the beginning of the file. As another example, |d0 cf 11 c0 a1 b1 1a e1| are the magic bytes associated with a Word file.

For example, FIG. 10 presents a protocol identification instance 1002 in accordance with one embodiment. FIG. 10 includes an indication 1004 that identifies a version field having the value SSL 2.0, which is SSLv2. In the hex file 1006, this can be identified 1008 as 0x0002.

FIG. 11 presents a protocol identification instance 1102 in accordance with another embodiment. Specifically, FIG. 11 presents a packet capture instance including an indication 1104 that identifies the protocol and version SSL 3.0, which is sslv3. In the hex file 1106, this can be identified 1108 as 0x0300.

FIG. 12 presents a protocol identification instance in accordance with another embodiment. FIG. 12 includes an indication 1204 that identifies a version field as having the value of TLS1.0. In the hex file 1206, this identified 1108 as 0x0301.

Referring back to FIG. 4, the inventory management module 408 may analyze network activity to identify devices that are on a network. Administrators may therefore maintain an accurate inventory by continuously monitoring network traffic and identifying new devices. In addition to identifying new devices, the inventory management module 408 may identify changes in existing devices. This may help to detect active devices in the network and assign policies based on active devices.

The inventory management module 408 may monitor network activity in a variety of ways. For example, the inventory management module 408 may monitor dynamic host configuration protocol (DHCP) discovery requests and add any new, identified devices based on the Source media access control (MAC) address present in the DHCP request. As another example, the inventory management module 408 may obtain source internet protocol (IP) addresses from domain name server (DNS) requests, and map the IP addresses to MAC addresses obtained from DHCP discovery requests.

In some embodiments, the inventory management module 408 may extract a source IP address from a packet that triggered a signature, and collect the vendor's name from metadata associated with the triggered signature. The source IP and vendor's name extracted from the triggered signature for that corresponding source IP may be stored in a data structure (not shown in FIG. 4).

The inventory management module 408 may implement passive operating system fingerprinting techniques. For example, operating systems may be associated with a known time-to-live (TTL) value. Accordingly, the inventory management module 408 may use an identified TTL value to identify the operating system. The embodiments herein may leverage data regarding the operating system to select signature(s). That is, the embodiments herein may select signatures that are relevant for that particular operating system.

Referring back to FIG. 2, the machine learning module(s) 206 may execute one or more machine learning models or procedures to identify data from network activity. In some embodiments, the machine learning module(s) 206 include or otherwise execute named entity recognition (NER) procedures to extract information from text. NER involves detecting and categorizing information known as named entities from text. Named entities refer to the key subjects of a piece of text such as, but not limited to, names, locations, companies, events, and products.

NER models can be built using the dataset of all the products and vendors. Datasets containing all the vendors and products can be prepared for training the model. If any product or vendor name is found in text, the NER model(s) may tag this as a product or vendor. This can be used to identify vendors or products in the network traffic. Data tagged by ML module(s) 206 may signify the presence of a product, vendor, service, etc., in the network.

The machine learning module(s) 206 may collect data regarding network traffic and normalize this data by extracting the field values and payload from the packets. This normalized data may then be fed to a NER model. Any text or data tagged by the NER model as products or vendors can be used to identify the software, products, vendors, or some combination thereof, in the network. This can be used to load signatures relevant to identified products, vendors, software, into RAM as discussed below.

In another embodiment, the machine learning module(s) 206 may use an encoder architecture that, given extracted text, predicts to what vendor or application a flow belongs. An example of an encoder architecture is the Bidirectional Encoder Representations from Transformers (BERT) by Google Inc., headquartered in Menlo Park, California. BERT models can be trained using the text extracted from flows from datasets of all the products and vendors. Given an unidentified flow, a trained model could predict to what vendor or application the flow belongs.

The UI module 208 may enable administrators or other interested parties to add data regarding vendors, software, products, etc., that are in use on the network. For example, an administrator may manually add this data via a user device executing a user interface.

In some embodiments, the firewall 10 may execute a feature such as a UI widget that is configured to receive comma-separated values (CSV) or JavaScript Object Notation (JSON) files containing a list of products or vendors. The UI module 208 may then parse the file(s) to obtain the objects in the list. Additionally, the UI module 208 may receive and parse security information and event management (SIEM) or Sys logs. This data may then be correlated with data gathered by other modules such as the telemetry module 202, the network profiler 204, etc.

Data from one or more of the modules 202-08 may be outputted and provided to the filter module 210. In some embodiments, the filter module 210 receives data from all modules 202-08. In some embodiments, the filter module 210 receives data from less than all four modules 202-08. The filter module 210 may perform any appropriate processing steps, such as cross-referencing data from multiple modules 202-08, removing duplicate data, or the like.

A configuration module 212 may receive output from the filter module 210 specifying data for selecting signatures. The configuration module 212 may reference one or more databases (not shown in FIG. 2) to determine which signatures should be selected for loading into random access memory (RAM). For example, if the configuration module 212 receives data indicating the FTP protocol is used on the network, the configuration module may identify signatures that are relevant to the FTP protocol.

The firewall 10 may include read only memory (ROM) 214 that is loaded with a full set of signatures 216. For example, during manufacturing of the firewall 10, the ROM 214 may be loaded with a full set of signatures 216, which may include a large amount (e.g., upwards of 30,000) signatures applicable to many different vendors, products, protocols, etc. The firewall 10 may then be shipped to customers without regard to characteristics of different, individual customer network environments.

Based on the data provided to the configuration module 212, however, only a subset of the full set of signatures 216 may be necessary or appropriate for the firewall 10. Accordingly, the configuration module 212 may select a customized set of signatures 220 to be loaded into RAM 218 of the firewall 10. The firewall 10 may then monitor traffic using the customized set of signatures 220.

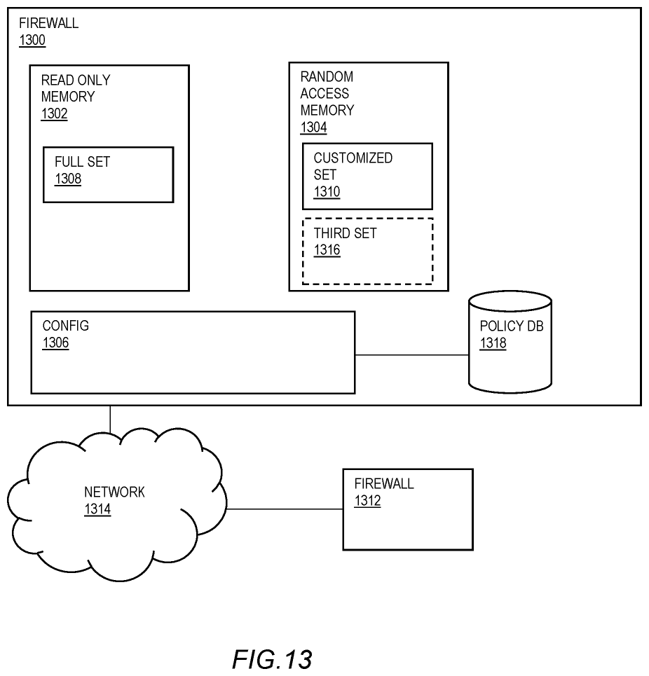

In some embodiments, one or more firewalls such as the firewall 10 may monitor traffic associated with different networks or subnets thereof. FIG. 13 illustrates a firewall 1300 including ROM 1302 and RAM 1304. The firewall 1300 may also include a configuration module 1306, as well as the other modules or components of the firewall 10 of FIG. 2.

As discussed previously, ROM 1302 may initially be configured with a full set of signatures 1308. The various modules of firewall 1300 such as those discussed in conjunction with FIG. 2 may have previously monitored network activity to select and load into RAM 1304 a customized set of signatures 1310 as discussed previously.

The firewall 1300 may be in communication with one or more firewalls 1312 over one or more networks 1314. Accordingly, the embodiments herein can monitor if, when, and where signatures are triggering globally, such as on other networks or subnets thereof. For example, the embodiments herein may execute a real-time application programming interface (API) or cloud-based service to receive and provide data regarding which signatures have triggered.

Accordingly, the firewall 1300 may leverage real-time, global event data from one or more networks 1314 or the other firewall(s) 1312. This global data may indicate how signatures have been used in policy options across global solutions or otherwise in other environments. If it is evident based on the global data that some signatures, including those in the customized set 1310, do not provide meaningful protection, the embodiments herein may remove these signatures from the customized set 1310 to create a third set 1316 with these signatures removed. In this scenario, the firewall 1300 may then monitor traffic using the third set of signatures 1316.

The firewall 1300 may also include or otherwise be in configuration with one or more policy databases 1318 specifying policies associated with the user or customer of the firewall 1300. For example, a customer or user of the firewall 1300 may specify whether they prioritize “protection” or “performance.” Some users may not need to be as strict in monitoring and flagging network activity. In some situations, the embodiments herein may only need to protect certain infrastructure, for example. In some situations, a customer may be tasked with protecting large amounts of personal information, and may therefore prioritize protection. In this case, the third set 1316 may be the same or approximately the same as the customized set 1310 (i.e., with very few or no signatures removed).

Another customer, however, may have a strong patching or maintenance program and may prioritize performance. In this case, the third set 1316 may be significantly smaller than the customized set 1310. For example, older signatures, such as those older than one year, may be removed from the customized set 1310 to create the third set 1316. The signatures loaded into RAM 1304, and those that remain in RAM 1304, may also be at least partially dependent on the memory or space limitations of the RAM 1304.

Customers may also deploy multiple firewall inspection instances at different locations on their network to achieve a higher throughput. Having the different signature sets 1308, 1310, and 1316 may therefore allow the customer to achieve performance gains by using different sets at different locations or at different times. Although three sets 1308, 1310, and 1316 are shown in FIG. 13, more than three sets may be used, wherein each set may be configured or used for a specific purpose.

This allows the customer to accommodate timing conditions or network changes. For example, whenever a new service executes on a network, such as by using a new port or a different protocol, the customer may opt to use a signature set with a larger number of signatures addressing the new service. If no signatures are triggered (e.g., after a predetermined period of time), the embodiments herein may use a signature set with fewer signatures than the enlarged set.

The embodiments herein provide novel features and advantages over existing techniques for monitoring network activity. For example, network security devices such as firewalls may monitor network activity using signatures that are most relevant to the network on which the firewall is tasked with monitoring activity. This improves the firewall's ability to protect the network or devices thereon as the firewall is using signatures most relevant to the network. That is, the firewall is using signatures that will identify the threats that are most likely to harm the network or devices thereon.

Additionally, the firewall's performance is improved as it is not using non-relevant signatures for scanning network activity. For example, the firewall would not be using computing resources to scan network activity using a signature associated with an operating system that is not even used on the network.

As the “full set” may always be shipped to a customer, such as at regular intervals or as a result of accumulation of updates, the disclosed embodiments allow all signatures relevant to a customer to be used. This is distinguishable from, for example, pre-defined signature sets that often result in not enough relevant signatures being included for certain environments or too many non-relevant signatures.

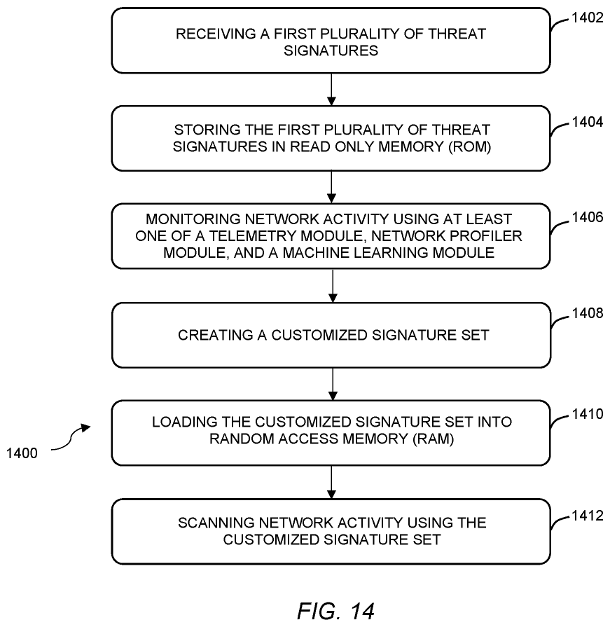

FIG. 14 depicts a flowchart of a method 1400 for detecting threats using threat signatures loaded in a computing device in accordance with one embodiment. The components of the firewall 10 of FIG. 2 may perform one or more of the steps of FIG. 14.

Step 1402 involves receiving a first plurality of threat signatures (e.g., the full set of signatures 216) at a computing device 10 on a first network location 154. The first plurality of threat signatures 216 may be a large set of signatures, where one or more signatures of the large set of signatures are not related to activity occurring on the first network location 154. Step 1404 involves storing the first plurality of threat signatures 216 in read only memory (ROM) 214 of the computing device 10.

Step 1406 involves monitoring, using the computing device, network activity by executing at least one of a telemetry module 202 to determine if a signature of the first plurality of threat signatures 216 has been triggered on the first network location, a network profiler module 204 to inspect data from a request-response transaction occurring on the first network location, and a machine learning module 206 to extract data associated with the network activity regarding a product, vendor, or application.

Step 1408 involves creating a customized signature set 220 by selecting a second plurality of threat signatures from the first plurality of threat signatures (e.g., the full set of signatures 216) based on output from the telemetry module 202, the network profiler module 204, the machine learning module 206, or some combination thereof. The customized signature 220 may be based on, for example, products, vendors, protocols, or some combination thereof, that are in use on the first network location 154.

Step 1410 involves loading the customized signature set 220 into random access memory (RAM) 218 of the computing device 10. Accordingly, only signatures that are relevant to the first network location 154 are actually loaded into RAM 218 to conserve computing resources.

Step 1412 involves scanning network activity using the customized signature set 220. The firewall 10 may then use the customized signature set 220, which includes the most relevant signatures for a customer's network 154, to scan activity occurring on the network 154.

According to one aspect, embodiments relate to a method for detecting threats using threat signatures loaded in a computing device. The method includes receiving a first plurality of threat signatures at a computing device on a first network location; storing the first plurality of threat signatures in read only memory (ROM) of the computing device; monitoring, using the computing device, network activity by executing at least one of: a telemetry module to determine if a signature of the first plurality of threat signatures has been triggered on the first network location, a network profiler module to inspect data from a request-response transaction occurring on the first network location, and a machine learning module to extract data associated with the network activity regarding a product, vendor, or application; creating a customized signature set by selecting a second plurality of threat signatures from the first plurality of threat signatures based on output from at least one or more of the telemetry module, the network profiler module, or the machine learning module; loading the customized signature set into random access memory (RAM) of the computing device; and scanning network activity using the customized signature set.

In some embodiments, the method includes referencing a policy associated with the first network location, wherein the policy indicates a preference for efficacy or a preference for performance, and the second plurality of threat signatures are selected based on the policy associated with the first network location.

In some embodiments, the method further includes executing a cloud-based service to gather telemetry data associated with at least a second network location and creating an optimized signature set by selecting a third plurality of threat signatures from the second plurality of threat signatures based on the gathered telemetry data associated with at least the second network location. In some embodiments, the method further includes referencing a policy associated with the first network location, wherein the policy indicates a preference for efficacy or a preference for performance, loading the optimized signature set of the third plurality of signatures into RAM of the computing device, and scanning network activity using the optimized signature set of the third plurality of signatures based on the policy associated with the first network location.

In some embodiments, the network profiler module is configured to parse a payload associated with network activity to identify at least one of a protocol used on the first network location, a vendor used on the first network location, a port used on the first network location, or an operating system used on the first network location.

In some embodiments, the network profiler module is configured to identify at least one of a product, vendor, or protocol used on the first network location by inspecting a banner in a request-response transaction on the first network location.

In some embodiments, the method further includes iterating, at a predetermined time interval, the steps of executing at least one of: the telemetry module to determine if a signature of the first plurality of threat signatures has been triggered on the first network location, the network profiler module to inspect data from a request-response transaction occurring on the first network location, and the machine learning module to extract data associated with the network activity regarding a product, vendor, or application; creating the customized signature set by selecting a second plurality of threat signatures from the first plurality of threat signatures based on output from at least one or more of the telemetry module, the network profiler module, or the machine learning module; loading the customized signature set into random access memory (RAM) of the computing device; and scanning network activity using the customized signature set.

In some embodiments, the method further includes executing an interface to receive a Security Information and Event Management (SIEM) log corresponding to network activity.

In some embodiments, the second plurality of signatures are selected based on signature age and Common Vulnerability Scoring System (CVSS) score.

According to another aspect, embodiments relate to a method for detecting threats using threat signatures loaded in a computing device. The method includes receiving a first plurality of threat signatures at a computing device on a first network location; storing the first plurality of threat signatures in random access memory (RAM) of the computing device; monitoring, using the computing device, network activity by executing at least one of: a telemetry module to determine if a signature of the first plurality of threat signatures has been triggered on the first network location, a network profiler module to inspect data from a request-response transaction occurring on the first network location, and a machine learning module to extract data associated with the network activity regarding a product, vendor, or application; transferring from the RAM of the computing device a set of non-relevant signatures to read only memory (ROM) of the computing device; retaining a customized signature set of a second plurality of threat signatures from the first plurality of threat signatures based on output from at least one or more of the telemetry module, the network profiler module, or the machine learning module; and scanning network activity accessible by the computing device using the customized signature set.

In some embodiments, the method further includes referencing a policy associated with the first network location, wherein the policy indicates a preference for efficacy or a preference for performance, and the second plurality of threat signatures are retained further based on the policy associated with the first network location.

In some embodiments, the method further includes executing a cloud-based service to gather telemetry data associated with at least a second network location and creating an optimized signature set by selecting a third plurality of threat signatures from the second plurality of threat signatures based on the gathered telemetry data associated with at least the second network location.

In some embodiments, the method further includes referencing a policy associated with the first network location, wherein the policy indicates a preference for efficacy or a preference for performance, retaining the optimized signature set of the third plurality of signatures in RAM of the computing device, and scanning network activity using the optimized signature set of the third plurality of signatures based on the policy associated with the first network location.

In some embodiments, the network profiler module is configured to parse a payload associated with network activity to identify at least one of a protocol used on the first network location, a vendor used on the first network location, a port used on the first network location, or an operating system used on the first network location.

In some embodiments, the network profiler module is configured to identify at least one of a product, a vendor, or a protocol used on the first network location by inspecting a banner in a request-response transaction on the first network location.

In some embodiments, the method further includes iterating, at a predetermined time interval, the steps of executing at least one of: the telemetry module to determine if a signature of the first plurality of threat signatures has been triggered on the first network location, the network profiler module to inspect data from a request-response transaction occurring on the first network location, and the machine learning module to extract data associated with the network activity regarding a product, vendor, or application; transferring from the RAM of the computing device a set of non-relevant signatures to read only memory (ROM) of the computing device; retaining a customized signature set of a second plurality of threat signatures from the first plurality of threat signatures based on output from at least one or more of the telemetry module, the network profiler module, or the machine learning module; and scanning network activity accessible by the computing device using the customized signature set.

In some embodiments, the method further includes executing an interface to receive a Security Information and Event Management (SIEM) log corresponding to network activity.

In some embodiments, the second plurality of signatures are selected based on signature age and Common Vulnerability Scoring System (CVSS) score.

According to yet another aspect, embodiments relate to a computer program product for detecting threats using threat signatures loaded in a computing device. The computer program product includes computer executable code embodied in one or more non-transitory computer readable media that, when executing on one or more processors, performs the steps of: receiving a first plurality of threat signatures at a computing device on a first network location; storing the first plurality of threat signatures in read only memory (ROM) of the computing device; monitoring, using the computing device, network activity by executing at least one of: a telemetry module to determine if a signature of the first plurality of threat signatures has been triggered on the first network location, a network profiler module to inspect data from a request-response transaction occurring on the first network location, and a machine learning module to extract data associated with the network activity regarding a product, vendor, or application; creating a customized signature set by selecting a second plurality of threat signatures from the first plurality of threat signatures based on output from at least one or more of the telemetry module, the network profiler module, or the machine learning module; loading the customized signature set into random access memory (RAM) of the computing device; and scanning network activity using the customized signature set.

In some embodiments, the computer program product further includes computer executable code that when executing one or more processors, performs the step of referencing a policy associated with the first network location, wherein the policy indicates a preference for efficacy or a preference for performance, and the second plurality of threat signatures are selected based on the policy associated with the first network location.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for detecting threats using threat signatures loaded in a computing device, the method comprising:
receiving a first plurality of threat signatures at a computing device on a first network location;
storing the first plurality of threat signatures in read only memory (ROM) of the computing device;
monitoring, using the computing device, network activity by executing at least one of:
a telemetry module to determine if a signature of the first plurality of threat signatures has been triggered on the first network location,
a network profiler module to inspect data from a request-response transaction occurring on the first network location, and
a machine learning module to extract data associated with the network activity regarding a product, vendor, or application;
creating a customized signature set by selecting a second plurality of threat signatures from the first plurality of threat signatures based on output from at least one or more of the telemetry module, the network profiler module, or the machine learning module;
loading the customized signature set into random access memory (RAM) of the computing device; and
scanning network activity using the customized signature set.

2. The method of claim 1 further comprising referencing a policy associated with the first network location, wherein the policy indicates a preference for efficacy or a preference for performance, and the second plurality of threat signatures are selected based on the policy associated with the first network location.

3. The method of claim 1 further comprising:
executing a cloud-based service to gather telemetry data associated with at least a second network location; and
creating an optimized signature set by selecting a third plurality of threat signatures from the second plurality of threat signatures based on the gathered telemetry data associated with at least the second network location.

4. The method of claim 3 further comprising:
referencing a policy associated with the first network location, wherein the policy indicates a preference for efficacy or a preference for performance;
loading the optimized signature set of the third plurality of signatures into RAM of the computing device; and
scanning network activity using the optimized signature set of the third plurality of signatures based on the policy associated with the first network location.

5. The method of claim 1 wherein the network profiler module is configured to parse a payload associated with network activity to identify at least one of a protocol used on the first network location, a vendor used on the first network location, a port used on the first network location, or an operating system used on the first network location.

6. The method of claim 1 wherein the network profiler module is configured to identify at least one of a product, vendor, or protocol used on the first network location by inspecting a banner in a request-response transaction on the first network location.

7. The method of claim 1 further comprising iterating, at a predetermined time interval, the steps of:
executing at least one of:
the telemetry module to determine if a signature of the first plurality of threat signatures has been triggered on the first network location,
the network profiler module to inspect data from a request-response transaction occurring on the first network location, and
the machine learning module to extract data associated with the network activity regarding a product, vendor, or application;
creating the customized signature set by selecting a second plurality of threat signatures from the first plurality of threat signatures based on output from at least one or more of the telemetry module, the network profiler module, or the machine learning module;
loading the customized signature set into random access memory (RAM) of the computing device; and
scanning network activity using the customized signature set.

8. The method of claim 1 further comprising executing an interface to receive a Security Information and Event Management (SIEM) log corresponding to network activity.

9. The method of claim 1 wherein the second plurality of signatures are selected based on signature age and Common Vulnerability Scoring System (CVSS) score.

10. A method for detecting threats using threat signatures loaded in a computing device, the method comprising:
receiving a first plurality of threat signatures at a computing device on a first network location;
storing the first plurality of threat signatures in random access memory (RAM) of the computing device;
monitoring, using the computing device, network activity by executing at least one of:
a telemetry module to determine if a signature of the first plurality of threat signatures has been triggered on the first network location;
a network profiler module to inspect data from a request-response transaction occurring on the first network location, and
a machine learning module to extract data associated with the network activity regarding a product, vendor, or application;
transferring from the RAM of the computing device a set of non-relevant signatures to read only memory (ROM) of the computing device;
retaining a customized signature set of a second plurality of threat signatures from the first plurality of threat signatures based on output from at least one or more of the telemetry module, the network profiler module, or the machine learning module; and
scanning network activity accessible by the computing device using the customized signature set.

11. The method of claim 10 further comprising referencing a policy associated with the first network location, wherein the policy indicates a preference for efficacy or a preference for performance, and the second plurality of threat signatures are retained further based on the policy associated with the first network location.

12. The method of claim 10 further comprising:
executing a cloud-based service to gather telemetry data associated with at least a second network location; and
creating an optimized signature set by selecting a third plurality of threat signatures from the second plurality of threat signatures based on the gathered telemetry data associated with at least the second network location.

13. The method of claim 12 further comprising:
referencing a policy associated with the first network location, wherein the policy indicates a preference for efficacy or a preference for performance;
retaining the optimized signature set of the third plurality of signatures in RAM of the computing device; and
scanning network activity using the optimized signature set of the third plurality of signatures based on the policy associated with the first network location.

14. The method of claim 10 wherein the network profiler module is configured to parse a payload associated with network activity to identify at least one of a protocol used on the first network location, a vendor used on the first network location, a port used on the first network location, or an operating system used on the first network location.

15. The method of claim 10 wherein the network profiler module is configured to identify at least one of a product, a vendor, or a protocol used on the first network location by inspecting a banner in a request-response transaction on the first network location.

16. The method of claim 10 further comprising iterating, at a predetermined time interval, the steps of:
executing at least one of:
the telemetry module to determine if a signature of the first plurality of threat signatures has been triggered on the first network location,
the network profiler module to inspect data from a request-response transaction occurring on the first network location, and
the machine learning module to extract data associated with the network activity regarding a product, vendor, or application;
transferring from the RAM of the computing device a set of non-relevant signatures to read only memory (ROM) of the computing device;
retaining a customized signature set of a second plurality of threat signatures from the first plurality of threat signatures based on output from at least one or more of the telemetry module, the network profiler module, or the machine learning module; and
scanning network activity accessible by the computing device using the customized signature set.

17. The method of claim 10 further comprising executing an interface to receive a Security Information and Event Management (SIEM) log corresponding to network activity.

18. The method of claim 10 wherein the second plurality of signatures are selected based on signature age and Common Vulnerability Scoring System (CVSS) score.

19. A computer program product for detecting threats using threat signatures loaded in a computing device, the computer program product comprising computer executable code embodied in one or more non-transitory computer readable media that, when executing on one or more processors, performs the steps of:
receiving a first plurality of threat signatures at a computing device on a first network location;
storing the first plurality of threat signatures in read only memory (ROM) of the computing device;
monitoring, using the computing device, network activity by executing at least one of:
a telemetry module to determine if a signature of the first plurality of threat signatures has been triggered on the first network location,
a network profiler module to inspect data from a request-response transaction occurring on the first network location, and
a machine learning module to extract data associated with the network activity regarding a product, vendor, or application;
creating a customized signature set by selecting a second plurality of threat signatures from the first plurality of threat signatures based on output from at least one or more of the telemetry module, the network profiler module, the machine learning module;
loading the customized signature set into random access memory (RAM) of the computing device; and
scanning network activity using the customized signature set.

20. The computer program product of claim 19, further comprising computer executable coded that, when executing one or more processors, performs the step of referencing a policy associated with the first network location, wherein the policy indicates a preference for efficacy or a preference for performance, and the second plurality of threat signatures are selected based on the policy associated with the first network location.
